(19) United States
(12) Patent Application Publication
(10) Pub. No.: US 2004/0015247 A1
(43) Pub. Date: Jan. 22, 2004

(54) Method and system for processing information indicative of frequency of reproduction of recorded information

(75) Inventor: Kazuhiro Kamiya, Kawagoe-shi (JP)

Correspondence Address: LADAS & PARRY, Suite #2100, 5670 Wilshire Boulevard, Los Angeles, CA, 90039-5679, US

(73) Assignee: PIONEER CORPORATION

(21) Appl. No.: 10/616,392

(22) Filed: Jul. 8, 2003

(30) Foreign Application Priority Data
Jul. 16, 2002 (JP) P2002-206461

(51) Int. Cl. G05B 13/02

(52) U.S. Cl. 700/51; 700/52

(57) ABSTRACT

There are provided a method and system for processing information indicative of a frequency of reproduction of information recorded on mediums, such as music data recorded on CDs. A reproduction-frequency information processing system has a plurality of terminals each configured to record pieces of information and to reproduce the recorded information and a server system communicably connected with terminals via communication means and configured to perform statistic processing on a reproduced condition of the recorded information at each terminal. Each terminal obtains reproduction-frequency information, every piece of the recorded information, depending on the reproduced condition, and transmits the obtained reproduction-frequency information to the server system in response to a request issued from the server system. The server system performs statistic processing on the received reproduction-frequency information for analysis, so that useful data concerning individual reproduction characteristics of users of the terminals can be provided.

### BACKGROUND OF THE INVENTION

1. Field of the Invention

The present invention relates to a method and system for processing information indicative of a frequency of reproduction of recorded information, such as data of music recorded on recording mediums.

2. Description of Related Art

In the music industry, a marketing research has been executed as a conventional way to find out consumer's needs. Concretely, for instance, taking a survey of sales of records in the shop and/or counting up the number of times of request in a cable broadcasting network have been carried out to make ranking the latest charts.

Companies such as an album production company use the results of the researches in order to offer a most marketable musical component to meet the needs of consumers who are potential buyers. In other words, the conventional music industry, which has followed an obvious buying interest, has existed by producing unquestioned marketable components.

In consequence, there has been a problem that potential music demand of a particular interest group with a smaller marketability in aspect of sales figures would not be developed.

As an additional problem, many of the musical components of a good demand in a recent trend are congenial to taste of teenagers. Accordingly, as one grows into adults, a marketable musical component becomes unsuited to his or her taste, which consequently encourages adult generation in turning off their interest in music, hindering the progress of music industry.

### SUMMARY OF THE INVENTION

The present invention has been made in view of the above circumstances, and an object of the present invention is, therefore, to provide a method and system for processing reproduction-frequency information, which are able to overcome, in any event, a problem that the music business has been prevented from growing due to the fact adults have narrowed their buying inclination to only their tastes.

In order to accomplish the above object, as one aspect of the present invention, there is provided a system for processing reproduction-frequency information, comprising: a plurality of terminals each configured to record one or more pieces of information and to reproduce the recorded information; and a server system communicably connected with the plurality of terminals via communication means and configured to perform statistic processing on a reproduced condition of the recorded information at the terminals, wherein each terminal comprises calculation means configured to calculate reproduction-frequency information, every piece of the one or more pieces of recorded information, depending on the reproduced condition of each of the one or more pieces of recorded information, information memorizing means configured to memorize the calculated reproduction-frequency information, reproduction-frequency information request receiving means configured to receive from the server system a request for the reproduction-frequency information, and terminal transmission means configured to transmit the memorized reproduction-frequency information to the server system; and wherein the server system comprises information request means configured to request a certain terminal for the reproduction-frequency information, reproduction-frequency information receiving means configured to receive the reproduction-frequency information from the terminal, and statistic processing means configured to perform the statistic processing based on the received reproduction-frequency information.

Further, as another aspect of the present invention, there is provided a method of processing reproduction-frequency information, which is carried out in a reproduction-frequency information processing system comprising: a plurality of terminals each configured to record one or more pieces of information and to reproduce the recorded information; and a server system communicably connected with the plurality of terminals via communication means and configured to perform statistic processing on a reproduced condition of the recorded information at the terminals, the processing method comprising the steps of: calculating reproduction-frequency information, every piece of the one or more pieces of recorded information depending on the reproduced condition of each of the one or more pieces of recorded information, the calculation being carried out in each of the terminals; memorizing the calculated reproduction-frequency information, the memorization being carried out in each of the terminals; receiving from the server system a request for the reproduction-frequency information, the reception being carried out in each of the terminals; and transmitting the memorized reproduction-frequency information to the server system, the transmission being carried out in each of the terminals; requesting a certain terminal for the reproduction-frequency information, the request being carried out in the server system; receiving the reproduction-frequency information from the terminal, the reception being carried out in the server system; and performing the statistic processing based on the received reproduction-frequency information, the performance being carried out in the server system.

### BRIEF DESCRIPTION OF THE DRAWINGS

Other objects and aspects of the present invention will become apparent from the following description and embodiments with reference to the accompanying drawings in which:

FIG. 1 is a block diagram exemplifying a outlined configuration of an entire system of an embodiment to which the present invention is applied:

FIG. 2 is a diagram showing the system of the present embodiment, which is depicted from the viewpoint of providing services;

FIG. 3 is a diagram showing the system of the present embodiment, which is depicted from the viewpoint of providing data;

FIG. 4 exemplifies the procedures for closing a contract between a user and a data-providing company;

FIG. 5 is a flowchart exemplifying flows in closing the contrast, which represent actions carried out when viewed from a reproduction terminal;

FIG. 6 is a view showing a terminal operation device and a terminal display on the reproduction terminal;

FIG. 7 exemplifies screens displayed on the reproduction terminal in acquiring a user ID;

FIG. 8 exemplifies screens displayed on the reproduction terminal after acquiring the user ID;

FIG. 9 exemplifies screens displayed in updating a system program including the reproduction-frequency information processing program;

FIG. 10 is a flowchart exemplifying the procedures in closing the contrast, which represent actions carried out when viewed from the data-providing company's server;

FIG. 11 is a flowchart which shows the procedures of download of the reproduction-frequency information processing program;

FIG. 12 is a flowchart showing the procedures of the reproduction-frequency information processing;

FIG. 13 exemplifies a music data object;

FIG. 14 exemplifies transmission and reception of data between a reproduction terminal and a server;

FIG. 15 exemplifies contents of the reproduction-frequency information to be transmitted and received;

FIG. 16 is a flowchart showing the procedures for transmitting and receiving the reproduction-frequency information, which are carried out by the reproduction terminal; and

FIG. 17 is a flowchart which shows the procedures for transmitting and receiving the reproduction-frequency information, which are carried out by the data-providing company's server.

### DETAILED DESCRIPTION OF PREFERRED EMBODIMENT

Referring to the accompanying drawings, a preferred embodiment of the present invention will now be explained.

The following embodiment is directed to a reproduction-frequency information processing system provided with a data-providing company's server which is placed in a data-providing company and which plays a key roll processing of reproduction-frequency information about music and a plurality of reproduction terminals each connected to the data-providing company's server via communication means. The reproduction-frequency information is information in relation to reproduction of music, such as the number of reproduction times for each piece of music, the reproduction being conducted by a user at the reproduction terminal, during a certain period of time.

1. Configuration of Reproduction-Frequency Information Processing System

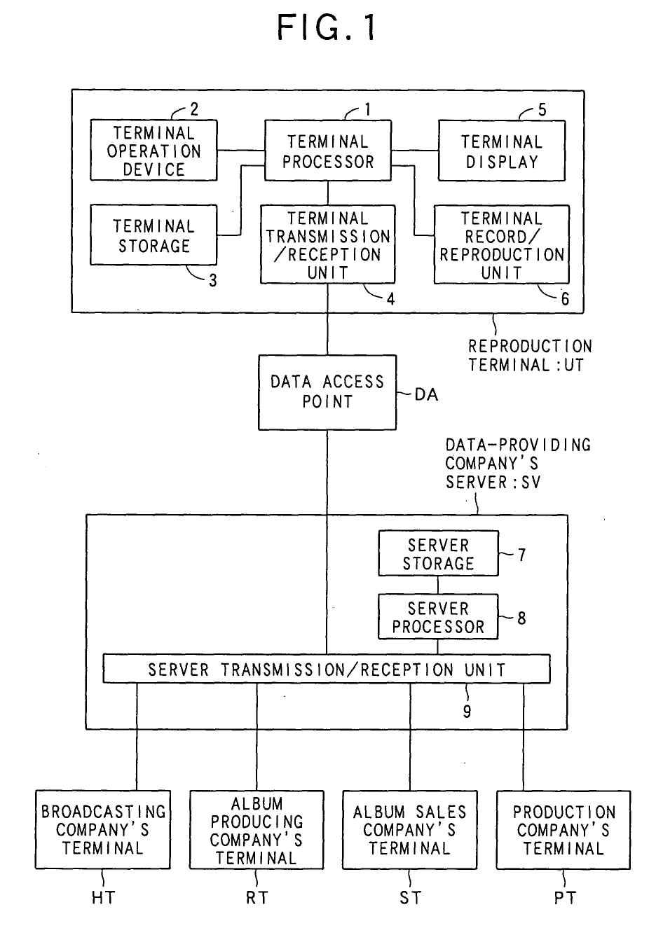

Referring to FIG. 1, the configuration of a reproduction-frequency information processing system according to the present embodiment will now be explained in detail.

FIG. 1 is a block diagram exemplifying the configuration of the reproduction-frequency information processing system.

As shown in FIG. 1, the reproduction-frequency information processing system is provided with a data-providing company's server SV, a reproduction terminal UT, a data access point DA, a broadcasting company's terminal HT, an album producing company's terminal RT, an album sales company's terminal ST, and a production company's terminal PT. Although FIG. 1 shows only one reproduction terminal UT and only one data access point DA, a plurality of reproduction terminals and a plurality of data access points are provided in the system (not shown), in practice.

The data access point DA is an access point usable by an unspecified number of users and is arranged at high-public locations, such as fast food places, convenience stores, and stations. One representative example of the data access point DA is Hot Spot (registered trademark). This data access point DA is located by taking it into account that a user who operates the reproduction terminal UT can easily have access to the data access point DA via the reproduction terminal UT during their daily life.

The data access point DA is connected with the data-providing company's server SV via a communication network so as to function as a relay station for transmission and reception of various types of information between the terminal UT and the data-providing company's server SV.

The reproduction terminal UT is provided with a terminal processor 1 having a calculation processing function, a terminal operation device 2 used to input user's various types of operational commands into the reproduction terminal UT, a terminal storage 3 for memorizing music data and various program data, a terminal transmission/reception unit 4 that is responsible for transmitting and receiving data to the data-providing company's server SV, a terminal display 5 that provides an operation-entering screen and displays a variety of types of information, and a terminal record/reproduction unit 6 that reproduces or records music data. In the terminal storage 3 is stored a reproduction-frequency information processing program according to the present invention. When this program is executed by the terminal processor 1, the terminal processor 1 is able to function as calculating means and identification sign request means. In addition, the terminal storage 3 serves as information memorizing means, the terminal transmission/reception unit 4 serves as reproduction-frequency information request receiving means, terminal transmission means, and identification sign reception means.

The reproduction-frequency information processing program is, as will be described later, delivered to the reproduction terminal UT via the data access point DA or others and stored in the terminal storage 3. Alternatively, the reproduction-frequency information processing program may be stored in the terminal storage 3 in advance.

The reproduction terminal UT is used by a user in such a manner that, for instance, music data such as popular songs distributed in markets on the Internet is downloaded to the reproduction terminal UT via the Internet or music data recorded on music CDs (Compact Discs) is recorded in the reproduction terminal UT, and the user listens to a playback of the recording. The reproduction terminal UT is made up of a portable reproduction device, such as an MP3 (MPEG Audio Layer-3) player in which a hard disk is incorporated, so that the reproduction terminal UT can be brought with a user when going out.

Specifically, in the reproduction terminal UT, music data is downloaded by way of the terminal transmission/reception unit 4 or recorded by way of the terminal record/reproduction unit 6, and then memorized in the terminal storage 3. When receiving a user's reproduction command at the terminal operation device 2, the music data is subjected to reproduction at the terminal record/reproduction unit 6.

The reproduction terminal UT can be connected to the data-providing company's server SV via the data access point DA. Both the reproduction terminal UT and the data access point DA are given a short-range wireless communication function based on, for example, Bluetooth (registered trademark) which is a known short-range wireless communication technique regulation. This allows the reproduction terminal UT to transmit and receive data to the data-providing company's server SV via the data access point DA.

Incidentally, the wireless access means which can be employed in this reproduction-frequency information processing system of the present invention is not limited to the Bluetooth (registered trademark), but other various techniques, including wireless LAN, UWB (Ultra Wide Band), wireless tag, ITS (Intelligent Transport Systems). Still, a mobile phone with a music reproducing function may also be used as the reproduction terminal.

The data-providing company's server SV will now be described. This server SV is provided with a server storage 7, a server processor 8, and a server transmission/reception unit 9. The server storage 7 is configured to memorize a reproduction-frequency information processing program. When this program is executed by the server processor 8, the server processor 8 is able to function as information request means, statistic processing means and recorded-information determining means. In addition, the server transmission/reception means 9 serves as reproduction-frequency information receiving means, identification sign request receiving means, and identification sign transmitting means.

Each of the broadcasting company's terminal HT, album producing company's terminal RT, album sales company's terminal ST, and production company's terminal PT is composed of a known computer system with a processor (such as CPU) having a calculation processing function, memories (such as ROM, RAM, hard disk) to memorize data and programs, and transmission/reception device (such as MODEM) used for connection with the Internet.

The broadcasting company's terminal HT, which is used in, for example, a company who broadcasts music programs and others, is composed of, for example, a personal computer system. This terminal HT can be connected with the data-providing company's server SV via a communication network and is able to transmit and receive, to and from the server SV, information that is subjected to reproduction-frequency information processing described later.

The album producing company's terminal RT, which is used in, for example, a company who produces music CDs and others, is composed of, for example, a personal computer system. This terminal RT can be connected with the data-providing company's server SV via a communication network and is able to transmit and receive, to and from the server SV, information that is subjected to reproduction-frequency information processing described later.

The album sales company's terminal ST, which is used in, for example, a company who sells music CDs and others, is composed of, for example, a personal computer system. This terminal ST can be connected with the data-providing company's server SV via a communication network and is able to transmit and receive, to and from the server SV, information that is subjected to reproduction-frequency information processing described later.

The production company's terminal PT, which is used in, for example, a company whose main business is planning and production of music-related events, is composed of, for example, a personal computer system. This terminal PT can be connected with the data-providing company's server SV via a communication network and is able to transmit and receive, to and from the server SV, information that is subjected to reproduction-frequency information processing described later.

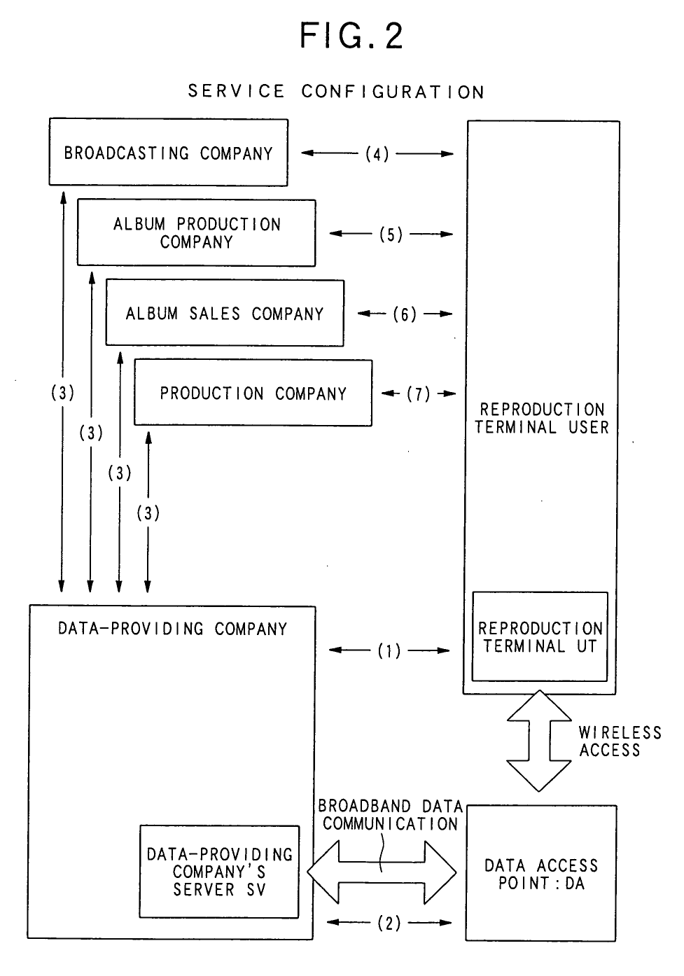

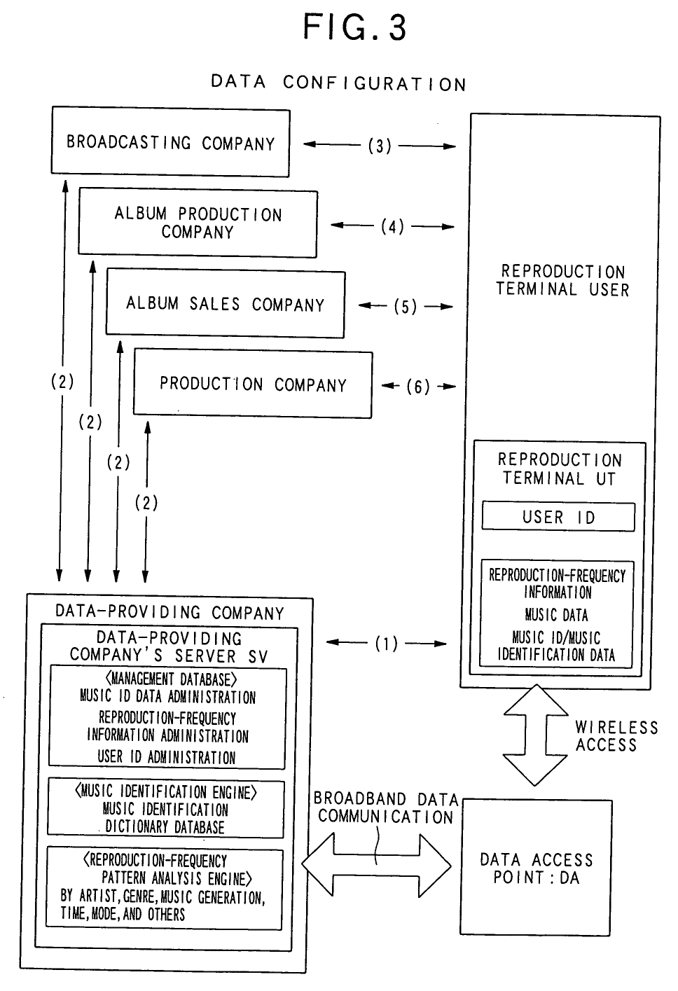

Referring to FIGS. 2 and 3, the reproduction-frequency information processing system of the present embodiment will now be described in terms of its providing various types of services and various data. FIG. 2 illustrates flows of serves to be provided in the system, while FIG. 3 illustrates flows of data to be provided in the system.

FIG. 2 will now be debriefed, in which the reproduction-frequency information processing system according to the present embodiment is depicted in connection with providing services.

A membership contract is closed between the data-providing company and a user who operates the reproduction terminal UT. The contract provides the contents that user's private reproduction-frequency information (that is, reproduction-frequency information calculated at the reproduction terminal UT owned by the user) is supplied from the user to the data providing company, while in return for the supply, the user is entitled to have preferential services, such as providing services of various type of information in preference to others, from the data providing company. Thus, the user provides the data providing company with user's reproduction-frequency information, and a service on the user's membership registration is provided from the data providing company to the user (refer to (1) in FIG. 2).

Further the data providing company closes a business contract with shops, such as convenience stores, concerning installation of the data access point DA. Thus, between the data providing company and those shops, various services are provided with each other, which include services about selling CDs and concert tickets and payment at the shops (refer to (2) in FIG. 2).

In addition, the data providing company closes another business contract with a music industry including a broadcasting company, an album producing company, an album sales company, and a production company. This business contract provides the supply of reproduction-frequency information accumulated at the data providing company to the music industry. That is, based on this business contract, information providing services about users are performed to the music industry and collecting charges for buying and selling and others is carried out (refer to (3) in FIG. 2).

Between each company in the music industry and the user, provided or carried out are various services including market research, supply of broadcasting program information, buying and selling of pieces of music, guidance of pieces of new music, and supply of event information (refer to (4) to (7) in FIG. 2).

Practically, information indicative of music to which the user listens at higher frequencies is provided, as reproduction-frequency information, from the user to each company in the music industry by way of the data providing company.

Thus the broadcasting company is able to make use of such information in producing programs, and a trend in the reproduction-frequency information are put to practical use in choosing new music recommended by the broadcasting company.

The album producing company makes use of the reproduction-frequency information in their advertisement activities, such as a guide of artists of user's favorite music, a genre of such music, and music in which an artist participates, and sales of music on the Internet, and supply of new music information.

The album sales company utilizes the reproduction-frequency information in such a manner that the reproduction-frequency information is subjected to extracting a trend (i.e., users' needs) which should be taken into account in producing music and a seed for the next hit tune is proposed. As a result, the information will be fed back to the users.

The production company utilizes the reproduction-frequency information to provide users with information about a guide of artists of user's favorite music, a genre of such music, and an event in the artist participates and to sell tickets.

FIG. 2 is a conceptual illustration for providing services, in which the services may be indirectly provided to users via the data access point DA and the data-providing company's server SV or may be directly provided to users through the Internet or others.

Next, referring to FIG. 3, the reproduction-frequency information processing according to the present embodiment will now be described about how data is circulated in the system.

A user who handles the reproduction terminal UT provides the data providing company with reproduction-frequency information of music to be targeted together with a music ID to identify a piece of music to be targeted (that is, data showing the title name of the music, artist name, genre of the music, and others) (refer to (1) in FIG. 3). If the music ID is unknown, music identifying data of a piece of music is provided to the data providing company.

The data providing company will provide each company in the music industry with data produced by analyzing the reproduction-frequency information (refer to (2) in FIG. 3).

In response to this providing action, to the user, the broadcasting company provides a broadcasting program (refer to (3) in FIG. 3), the album producing company provides music (refer to (4) in FIG. 3), the album sales company provides music software (refer to (5) in FIG. 3), the production company provides information data in relation to events and guides to music (refer to (6) in FIG. 3), respectively.

FIG. 3 is a conceptual illustration for providing a variety of kinds of data, in which the data may be indirectly provided to users via the data access point DA and the data-providing company's server SV or may be directly provided to users through the Internet.

2. Contract Required by the Reproduction-Frequency Information Processing System According to the Present Embodiment

An example of a contract, which forms a premise in the reproduction-frequency information processing system, will now be outlined, which is based on supply of information carried out between each user and the data providing company, and between the data providing company and each company in the music industry. The contract focuses on providing actions of various types of information transferred therebetween.

Closing a membership contract between each user who operates the reproduction terminal UT and the data providing company will lead to the protection of user's private information, such as user management information and user information.

This contract can be made at a shop when the user first buys the reproduction terminal UT, made at a shop at which the user bought the reproduction terminal UT before, made using an online signup through a personal computer, or made by mail. Of these techniques for the contract, the online signup is carried out such that data in relation to a user is first inputted at the personal computer, and then subjected to the authentication. When it is found that the user passes the authentication, a provisional ID is issued. Since the reproduction terminal UT has its own ID number, the user inputs the acquired provisional ID at the reproduction terminal UT to have access to the data-providing company's server SV via the data access point DA. This access completes the contract procedures, so that the user is able to use the functions based on the contract contents at the reproduction terminal UT.

For accomplishing the contract, required is data indicative of user's private information (for example, name, gender, age, address and others) and a certificate for identifying the user (for example, identification card). Additionally, to have the function of electronic payment that allows a user to buy music data on the Internet, it is also necessary to provide data supporting the payment, such as user's credit card number. Through these procedures, the user is able to have various kinds of information services.

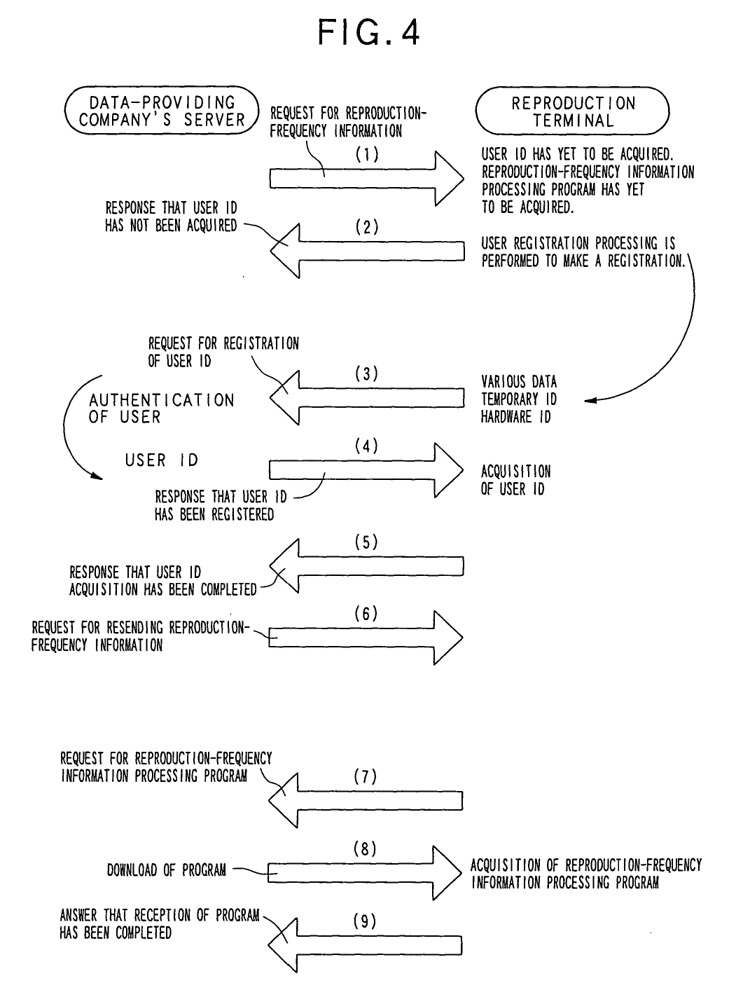

A flow of procedures involved in closing the contract will now be explained in connection with FIGS. 4 to 6.

Using FIG. 4, the contract closed between each user and the data providing company will now be explained procedure by procedure.

In the following, information necessary to be communicated between the data-providing company's server SV and the reproduction terminal UT will transmitted and received via the foregoing data access point DA.

First of all, the data-providing company's server SV requests the reproduction terminal UT for reproduction-frequency information (refer to (1) in FIG. 4).

If the user who owns the reproduction terminal UT is yet to acquire a user ID and is yet to acquire a reproduction-frequency information processing program, the user operates the terminal operation device 2 to send necessary information for user contract processing.

That is, a response to show that the user ID has yet to be acquired is sent from the reproduction terminal UT to the data-providing company's server SV (refer to (2) in FIG. 4).

The user then operates the terminal operation device 2 of the reproduction terminal UT to input necessary data such as a provisional ID acquired through a provisional contract executed at a shop, with the result that a user ID registration request is sent to the data-producing company's server SV (refer to (3) in FIG. 4).

In the data providing company, the data-providing company's server SV will execute authentication on the received data. If the authentication reveals that the user is identified, the server SV generates a user ID and sends a response of the generated user ID registration to the reproduction terminal UT (refer to (4) in FIG. 4).

In response to the user ID registration response from the data-providing company's server SV, the reproduction terminal UT stores the received user ID in the terminal storage 3, before sending back to the data-providing company's server SV a response to notify that the user ID acquisition has been completed (refer to (5) in FIG. 4).

When receiving the response notifying the completion of the user ID acquisition from the reproduction terminal UT, the data-providing company's server SV will then transmit a resending request for reproduction-frequency information to the reproduction terminal UT (refer to (6) in FIG. 4).

The reproduction terminal UT, which has received the resending request for the reproduction-frequency information, responds by issuing a request the data-providing company's server SV for a reproduction-frequency information processing program (refer to (7) in FIG. 4).

When receiving the request for the reproduction-frequency information processing program, the data-providing company's server SV will send to the reproduction terminal UT a reproduction-frequency information processing program depending on the type of the reproduction terminal UT. Responsively to this transmission, the reproduction terminal UT is able to download the transmitted reproduction-frequency information processing program (refer to (8) in FIG. 4).

On completion of the download, the reproduction terminal UT sends back to the data-providing company's server SV a response that the download of the reproduction-frequency information processing program has been completed (refer to (9) in FIG. 4).

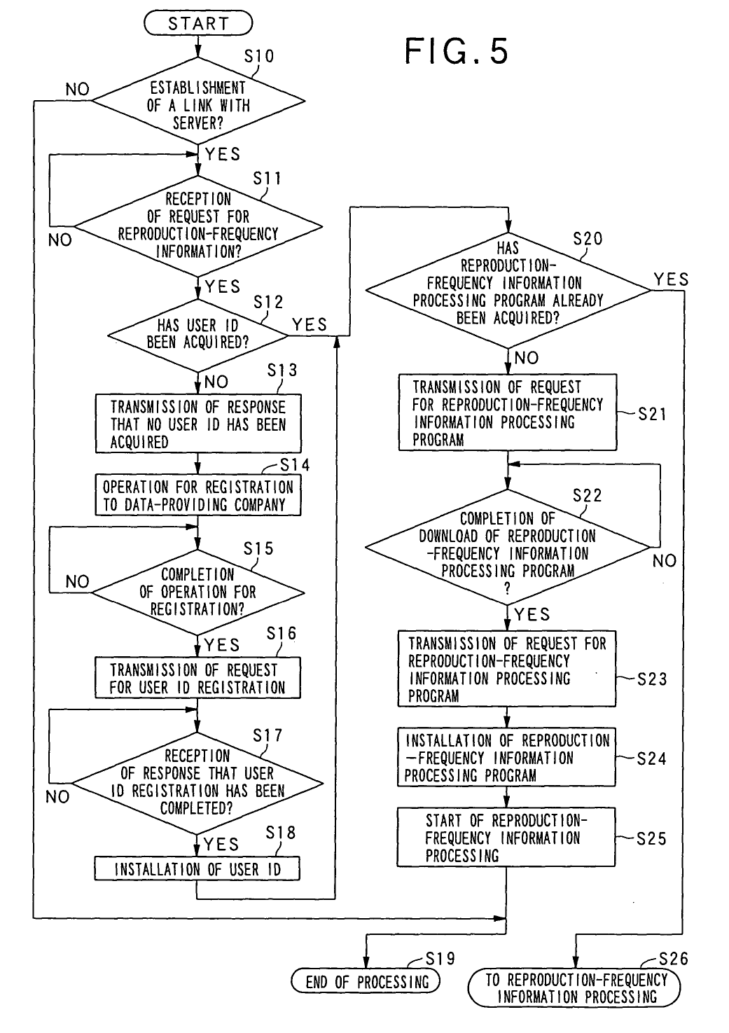

Referring to FIG. 5, a series of procedures for the contract to be closed between the data providing company and a user who owns the reproduction terminal UT will now be described, the procedures being expressed from the standpoint of the reproduction terminal UT.

FIG. 5 is a flowchart showing the procedures required for user registration to realize the contract, which are viewed from the reproduction terminal UT, wherein the terminal processor 1 first determines whether or not there is established a link with the data-providing company's server SV (step S10 in FIG. 5).

When no link with the data-providing company's server SV is established (NO at step S10), the processing is ended (step S19).

In contrast, when a link with the data-providing company's server SV is established (YES at step S10), the terminal processor 1 then determines whether the terminal UT has received a reproduction-frequency information request from the data-providing company's server SV (step S11).

If this determination shows that such a reproduction-frequency information request has not been received yet (NO at step S11), the terminal processor 1 keeps monitoring at step S11.

In contrast, when it is determined that the reproduction-frequency information request has been received from the data-providing company's server SV (YES at step S11), the terminal processor 1 then determines if or not a user ID is memorized in the terminal storage 3 (step S12).

When it is determined that the user ID is memorized in the terminal storage 3, that is, the reproduction terminal UT has already acquired the user ID (YES at step S12), the terminal processor 1 will proceed to the next determination where it is determined whether a reproduction-frequency information processing program is installed or not (step S20).

In this processing, when it is determined that the reproduction-frequency information processing program is installed (YES at step S20), the terminal processor 1 will proceed to processing for reproduction-frequency information (step S26).

However, it is determined that the reproduction-frequency information processing program has yet to be installed (NO at step S20), the terminal processor 1 sends a request for the reproduction-frequency information processing program to the data-providing company's server SV (step S21).

Then the terminal processor 1 determines, through its monitoring, whether or not the download of the reproduction-frequency information processing program from the data-providing company's server SV has been completed (step S22).

When it is determined that the download has yet to be completed (NO at step S22), the terminal processor keeps monitoring at step S22. In contrast, if it is determined that the download of the reproduction-frequency information processing program has been completed (YES at step S22), the terminal processor 1 takes an action to transmit, to the data-providing company's server SV, a response notifying that the reproduction-frequency information processing program has been received (step S23).

The terminal processor 1 then proceeds to an operation by which the downloaded reproduction-frequency information processing program is installed (step S24).

After the installation, the terminal processor 1 allows the reproduction-frequency information processing to start, and terminates the contract processing (step S19).

By the way, when it is determined at step S12 that the user ID is not stored in the terminal storage 3, namely, the reproduction terminal UT has not acquired the user ID yet (NO at step S12), the terminal processor 1 will transmit to the data-providing company's server SV a message to notify that the user ID is yet to be acquired (step S13).

The terminal processor 1 then enables the terminal display 5 to display an operation screen for the contract with the data providing company (step S14). This operation screen guides user's input operations for the contract.

The terminal processor 1 determines, through its monitoring the user's operations, whether or not the user has inputted all the necessary information at the displayed contract operation screen, that is, all the necessary items including the already acquired provisional ID have been filled in on the screen (step S15).

When this determination shows that the necessary items are yet to be filled in (NO at step S15), the determination at step S15 is kept.

In contrast, the above determination at step S15 shows an affirmative result, that is, all the necessary items have been given by the user so that the input operations have been completed (YES at step S15), the terminal processor 1 sends a request for registration of an user ID to the data-providing company's server SV (step S16).

The terminal processor 1 then goes to the processing to determine whether or not the reproduction terminal UT has received from the data-providing company's server SV a response notifying that the user ID registration has been completed (step S17).

If this determination is that such a response notifying the completion of the user ID registration has not been received yet (NO at step S17), the terminal processor 1 will keep monitoring at step S17.

In contrast, when it is determined that the response notifying the completion of the user ID has been received from the data-providing company's server SV (YES at step S17), the terminal processor 1 enables the terminal storage 3 to memorize the received user ID (step S18).

On completing such memorization, the processing in the terminal processor 1 is made to go to step S20, where the foregoing procedures at steps S20 to S26 will be carried out.

The operation at the terminal operation device 2 of the reproduction terminal UT will now be exemplified.

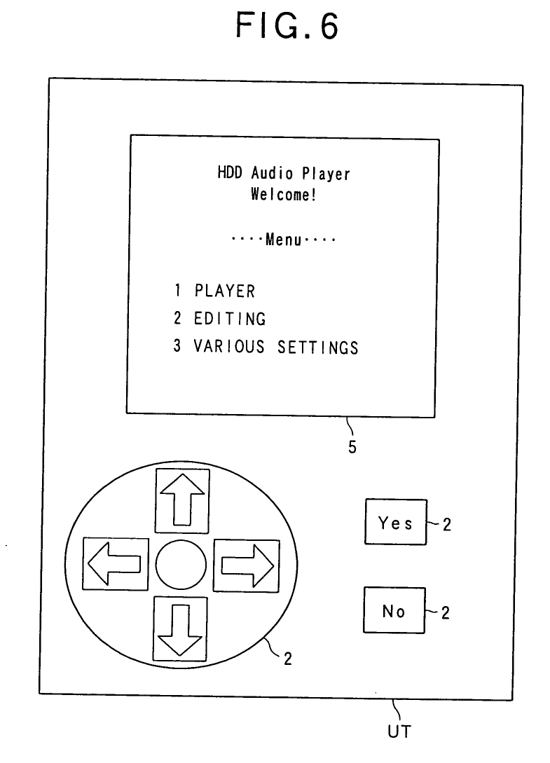

FIG. 6 exemplifies the terminal operation device 2 and the terminal display 5 of the reproduction terminal UT.

As shown in FIG. 6, the reproduction terminal UT is provided, as described before, in an integral form, the terminal display 5 to provide a screen on which various pieces of information are displayed and the terminal operation device 2 that includes various keys, such as directional keys, selection key, and Yes/No keys. This key system permits a user to operate the reproduction terminal UT in a simple manner, with cumbersome input operations avoided.

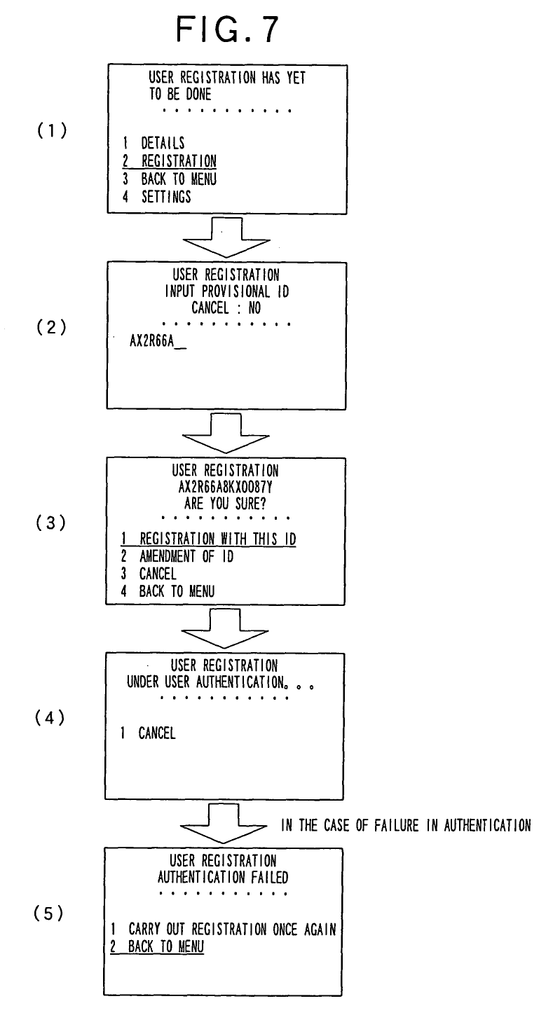

FIG. 7 exemplifies how the display screen of the reproduction terminal UT changes depending on progress in operations for acquiring the user ID.

A user who closed the contract with the data providing company at a shop or other places is nothing more than having a provisional ID, as described before. Hence, when receiving a reproduction-frequency information request from the data-providing company's server SV at the data access point D, the terminal processor 1 displays, on the terminal display 5, a message that a formal user registration has not been completed (refer to (1) in FIG. 7).

In order to execute the formal user registration procedures, the user operates the directional keys at the terminal operation device 2 to select “2. registration” on the screen.

When receiving the selection, the terminal processor 1 makes the terminal display 5 provide thereon an entering screen for the provisional ID (refer to (2) in FIG. 7). Thus, the user operates the directional keys on the terminal operation device 2 to input the previously acquired provisional ID, and pushes the decision key when completing the input.

In response to the user's input operation, the terminal processor 1 operates to display, on the terminal display 5, a user's input decision and confirmation screen (refer to (3) in FIG. 7). If the user finds no error in the user-inputted provisional ID, the user will select “1. registration with this ID,” before pushing the Enter key on the terminal operation device 2.

The terminal processor 1 sends the provisional ID to the data-providing company's server SV, and then provides, on the terminal display 5, a message showing that it is now under user authentication (refer to (4) in FIG. 7).

In the case that the terminal processor 1 receives a response notifying failure in the user authentication from the data-providing company's server SV, the terminal processor 1 displays a message notifying such failure on the terminal display 5 (refer to (5) in FIG. 7).

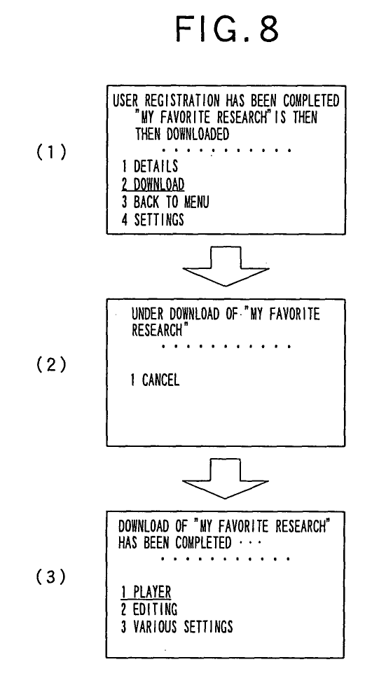

FIG. 8 exemplifies how the display screen of the registration terminal UT changes after the acquisition of the user ID.

After completing the acquisition of the user ID through the foregoing user ID acquisition procedures, the terminal processor 1 will receive from the data-providing company's server SV a message that the user ID acquisition has been completed, and then provides the message on the terminal display 5 (refer to (1) in FIG. 8). In this case, it is required that the reproduction-frequency information processing be started as soon as after the completion of the registration, the terminal processor 1 keeps downloading the reproduction-frequency information program.

The user operates the durational keys on the terminal operation device 2 to select an item of “2. download” from the decision branches displayed on the screen of the terminal display 5, and then pushes the decision key.

This user's decision operation permits the terminal processor 2 to send a request for a reproduction-frequency information processing program to the data-providing company's server SV, during which waiting time a wait screen is displayed on the terminal display 5 (refer to (2) in FIG. 8).

When the download has been finished, the screen on the terminal display 5 will be returned to its normal state (refer to (3) in FIG. 8).

By the way, any user's operations are not required during the transmission and reception of reproduction-frequency information, so that the contents to be displayed on the screen of the terminal display 5 are kept in the normal.

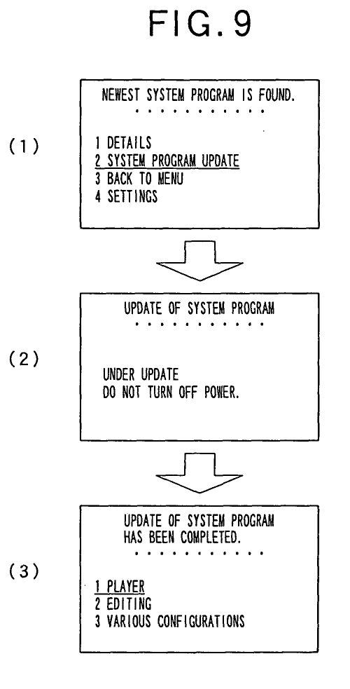

FIG. 9 exemplifies how the screen of the terminal display 5 changes responsively to operations in cases where a system program including the reproduction-frequency information processing program is updated. The relationship between the system program and the reproduction-frequency information processing program is similar to those in the computer. The system program corresponds to, for instance, an OS (Operating System) program or BIOS (Basic Input Output System) installed in the computer, while the reproduction-frequency information processing program corresponds to an application program working on the OS. Thus updating the system programs will cause the reproduction-frequency information processing program to be updated as well.

In the case that the system program installed in the reproduction terminal UT is not the newest version, the terminal processor 1 will provides a system program update screen on the terminal display 5 (refer to (1) in FIG. 9).

Thus, the user operates the directional key on the terminal operation device 2 to select an item “2. system program update” on the screen, and then pushes the decision key.

The terminal processor 1 requests the data-providing company's server SV for updating the system program, and then making the download of the program begin. During the download operation, a wait screen is provided on the terminal display 5 (refer to (2) in FIG. 9). Moreover, in order to avoid an accident that the terminal processor cannot able to start up after errors happen in rewriting data for the update, the newest system program to be installed is downloaded temporarily into a buffer memory of the reproduction terminal UT, and then the memory is rewritten with the downloaded data after completion of the download.

When the update of the system program has been completed, the display screen is returned to the normal (refer to (3) in FIG. 9).

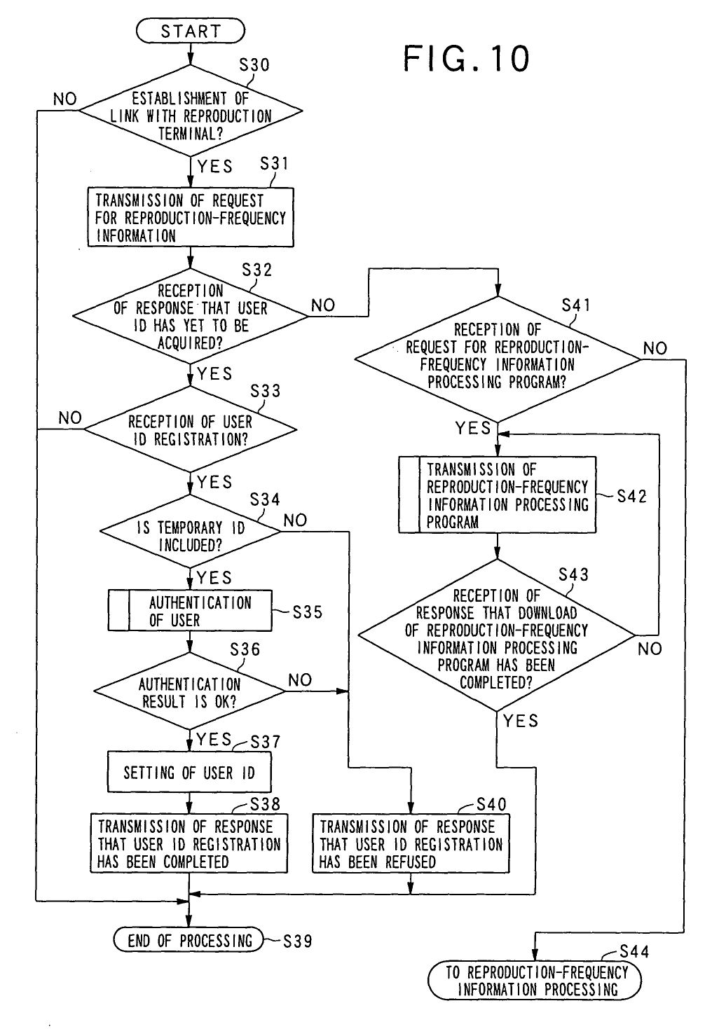

In connection with FIG. 10 a series of procedures for the contract to be closed between the data providing company and a user who owns the reproduction terminal UT will now be described, the procedures being expressed from the standpoint of the data providing company.

FIG. 10 is a flowchart showing the procedures required for user registration to realize the contract, which are viewed from the data-providing company's server SV.

First, the server processor 6 determines if there is established a link with the reproduction terminal UT or not (step S30 in FIG. 10).

If it is determined that the link has not been established (NO at step S30), the processing is ended (step S39), while if it is determined that the link is established (YES at step S30), the server processor 8 send to the reproduction terminal UT a request for reproduction-frequency information (step S31).

The server processor 8 then goes to a determination whether or not there is a response notifying that a user ID is yet to be acquired (step S32).

When it is determined that a response notifying the user ID is yet to be acquired has been received (YES at step S32), the server processor 8 further goes to a determination whether or not there is a request for registering an user ID from the reproduction terminal UT (step S33).

Meanwhile, the determination shows that there is no such a request for the user ID registration (NO at step S33), the processing by the server processor 8 is forced to end (step S39).

In this determination, when it is determined that the user ID registration request has been issued (YES at step S33), the server processor 8 proceeds to a determination whether or not the information from the reproduction terminal UT includes a provisional ID (step S34).

In the case that it is determined that there includes the provisional ID (YES at step S34), the server processor 8 authenticates a user on the information transmitted from the reproduction terminal UT (step S35). Accordingly, the server processor 8 determines whether or not the user has been authenticated (step S36).

When it is determined that the user has been authenticated (YES at step S36), the server processor 8 generates a user ID and registers the generated user ID into the database in the server storage 7 (step S37).

After the registration, the server processor 8 further transmits to the reproduction terminal UT both of the generated user ID as well as information notifying that the user ID registration has been completed (step S38).

On completing the above transmission to the reproduction terminal UT, the processing is ended (step S39).

Meanwhile, at step S34, when it is determined if the provisional ID has not been included in the information from the reproduction terminal UT (NO at step S34), the server processor 8 sends, to the reproduction terminal UT, a response to notify that the user ID registration has been rejected (step S40), before terminating the processing (step S39).

If it is determined at step S36 that the user has been authenticated (NO at step S36), the server processor 8 sends, to the reproduction terminal UT, a response to notify the rejection of the user ID registration (step S40), and then ends the processing (step S39).

In the case that it is determined at step S32 that the response shows the acquisition of the user ID (NO at step S32), the server processor 8 further determines if there is a request for a reproduction-frequency information processing program issued from the reproduction terminal UT (step S41).

When it is determined that there is no request for the reproduction-frequency information processing program from the reproduction terminal UT (NO at step S41), the server processor 8 shifts its processing to reproduction-frequency information processing (step S44).

In contrast, when it is determined that there is the reproduction-frequency information processing program request from the reproduction terminal UT (YES at step S41), the server processor 8 transmits the reproduction-frequency information processing program to the reproduction terminal UT (step S42).

The server processor 8 then determines if or not there is a response notifying that the reception of the reproduction-frequency information processing program has been completed (step S43).

If there is no response notifying the completion of such reception (NO at step S43), the processing is made to return to step S42, wherein the reproduction-frequency processing program is sent to the reproduction terminal UT.

By contrast, if there has been the response notifying the completion of such reception (YES at step S43), the processing is ended (step S39).

3. Processing of Reproduction-Frequency Information

Processing of reproduction-frequency information carried out in the reproduction terminal UT will now be described.

First of all, the “reproduction frequency” is defined. In the reproduction-frequency information processing system according to the present embodiment, the “reproduction frequency” is defined as a frequency showing how frequently a piece of music to be targeted is listened by a user during a given interval of time. In order to quantitatively explain the reproduction frequency, a concept of “reproduction time rate” is introduced. The reproduction time rate is an index to show how frequently a piece of music to be targeted is reproduced (replayed) by the reproduction terminal UT, which is expressed by the following formula:

$$Reproduction time rate = ( actually reproduced time of music to be targeted ) / ( reproduction time of music to be targeted )$$

The “actually reproduced time of music to be targeted” indicates a period of time during which the reproduced (replayed) state of the music is kept sequentially in time,” while the “reproduction time of music to be targeted” indicates a period of time required to reproduce (replay) the music from beginning to end.

In cases where the reproduction time rate that is figured out is larger than a threshold, it is judged that the reproduction of a piece of music to be targeted is carried out “one time.” The threshold is set to remove particular situations where the music is reproduced partly during a shorter period of time (for instance, only the intro part of each piece of music is replayed), whereby erroneously counting, which miscalculates each of such cases as one time of reproduction of the music, can be avoided or remarkably reduced.

The number of times of reproduction that is thus calculated is treated as information indicating the reproduction frequency, or the reproduction-frequency information.

The reproduction-frequency information processing is designed so that this program is active only after the user registration is made at the data providing company.

The reproduction-frequency information processing program for processing the reproduction frequency information is taken, under wireless access, into the reproduction terminal UT when the user registration is done at the data providing company or the newest system program is downloaded.

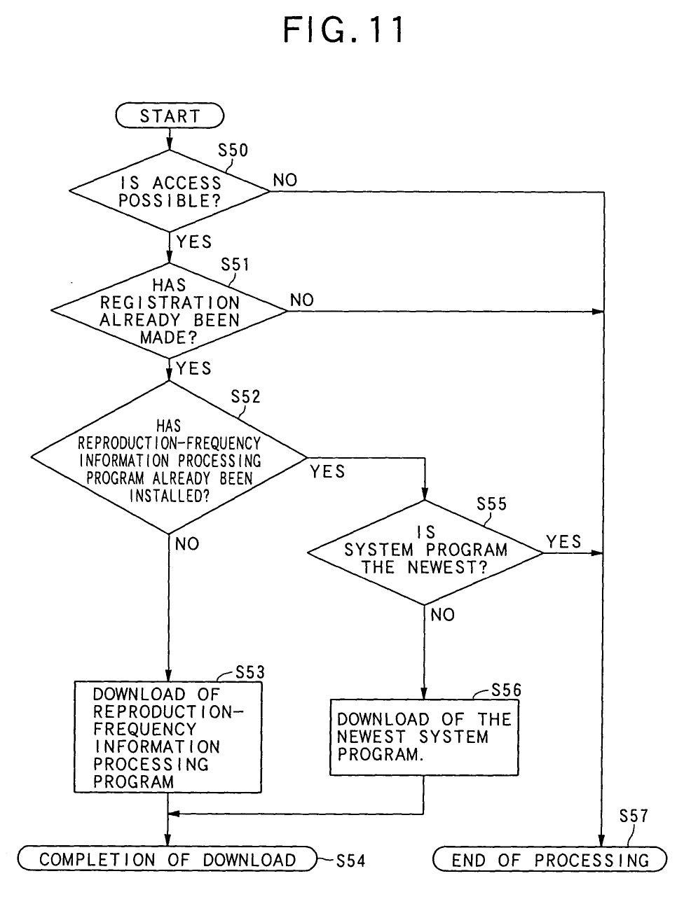

Referring to FIG. 11, a flow of procedures to download the reproduction-frequency information processing program will now be described. FIG. 11 shows a flowchart exemplifying such downloading procedures.

The terminal processor 1 of the reproduction terminal UT determines whether the terminal/reception unit 4 is in wireless accessible to the data access point DA (step S50 in FIG. 11).

If it is determined that the terminal/reception unit 4 is not in wireless accessible to the data access point DA (NO at step S50), the processing ends (step S57).

On the other hand, when it is determined that the terminal/reception unit 4 is in wireless accessible to the data access point DA (YES at step S50), the terminal processor 1 further determines if the user who owns this reproduction terminal UT has closed the user contract with the data providing company (step S51).

If the determination shows a negative result, that is, no user contract has been closed (NO at step S51), the processing ends (step S57). However, the determination at step S51 is the opposite, that is, the user contract has been closed (YES at step S51), the terminal processor 1 goes to a further determination whether or not the reproduction-frequency information processing program is installed in the reproduction terminal UT (step S52).

When the determination shows that the reproduction-frequency information processing program is yet to be installed in the terminal UT (NO at step S52), the reproduction-frequency information processing program is downloaded from the data-providing company's server SV to the terminal UT via the data access point DA (step S53).

On completion of the download, the reproduction-frequency information processing program becomes an installed program in the reproduction terminal UT (step S54).

In contrast, at step S52, it is determined that the reproduction-frequency information processing program is installed in the reproduction terminal UT (YES at step S52), the terminal processor 1 will further proceed to a determination whether the system program is the newest version or not (step S55).

When the determination show that the program version is not the newest (NO at step S55), the system program will be downloaded from the data-providing company's server SV to the terminal UT via the data access point DA (step S56).

With the download completed, the newest-version system program takes over the old one in the reproduction terminal UT, so that the reproduction-frequency information processing program is updated to the newest version in association of the updated system program (step S54).

When it is determined at step S149 that the newest-version system program is installed (YES at step S55), the processing ends (step S57).

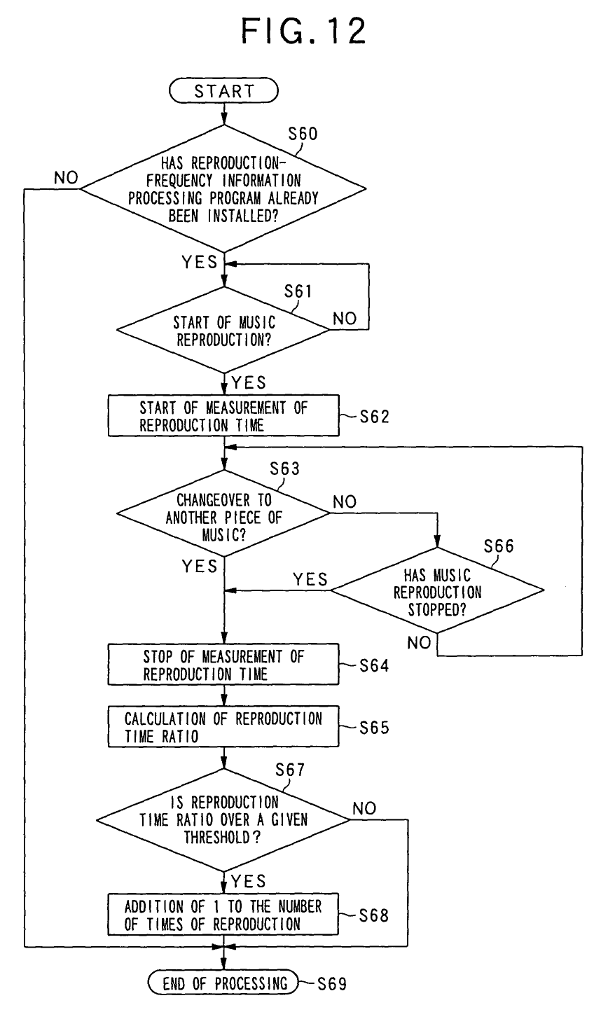

Next, referring to FIG. 12, the reproduction-frequency information processing will now be described. FIG. 12 exemplifies a flowchart for the procedures for the processing.

In the reproduction terminal UT, the terminal processor 1 determines if the reproduction-frequency information processing program is installed in the reproduction terminal UT or not (step S60 in FIG. 12).

If it is determined that the program is not installed (NO at step S60), the reproduction-frequency information processing will not be carried out (step S69). However, if it is determined that the reproduction-frequency information processing program is installed (YES at step S60), the terminal processor 1 goes to another determination where the terminal record/reproduction unit 6 is about to start to reproduce a piece of music (step S61).

If the reproduction of the music is not started (NO at step S61), the processing at step S61 is repeated to monitor the start of reproduction of the music.

In contrast, if the reproduction of the music is about to start (hereafter, the music is referred to as “music A”; YES at step S61), the terminal processor commences the measurement of a period of time during which the music A is reproduced (which is simply referred to as a reproduction time; step S62).

The terminal processor 1 checks if or not the music A currently reproduced has been changed to another piece of music in the course of reproduction of the music A (step S63).

If the music A under reproduction has been changed to another piece of music, the terminal processor stops measuring the reproduction time of the music A (step S64).

After stopping measuring the reproduction time of the music A, the terminal processor 1 calculates a reproduction time rate, which has been described before (step S65).

In cases where, at step S63, it is determined that the currently reproduced music A has not been changed to another one (NO at step S63), the terminal processor 1 proceeds to another determination whether or not the reproduction of the music A has been stopped (step S66). Through this determination, various modes of situations are determined, which includes a situation where the entire music A has been reproduced from beginning to end, another situation where the reproduction has been changed to another source in the course of reproduction of the music A, or another situation where the power has been turned off in the course of reproduction of the music A. Incidentally, temporary stop operations, such as posing, are not included in the stop monitored at step S66, as long as there is still a possibility that the reproduction will continue again after the temporal stop.

If it is determined that the reproduction of the music A has continued (NO at step S66), the processing is returned to step S63. In contrast, if it is determined that the reproduction of the music A has been stopped (YES at step S66), the terminal processor 1 performs the foregoing processing at steps S64 and S65.

On completion of calculating the reproduction time rate of the music A at step S66, the terminal processor 1 determines whether or not the calculated reproduction time rate is over a given threshold previously set (step S67).

When it is found that the calculated reproduction time rate for the music A is over the given threshold previously set (YES at step S67), the terminal processor 1 recognizes that the music A has been reproduced “one time,” and performs an increment of data showing the number of reproduction times of the music A, that is, add “1” to the data (step S68).

The data of reproduction times that has been subjected to the addition of “1” becomes the newest data of reproduction times, and is memorized in the terminal storage 3 as reproduction-frequency information, before the reproduction-frequency information processing is ended (step S69).

On the other hand, if it is determined that the calculated reproduction time rate for the music A is equal to or below the given threshold previously set (NO at step S67), the terminal processor 1 goes directly to the end of the reproduction-frequency information processing, with the current amount of the data of reproduction times kept without adding “1” to the data (step S69).

In the terminal storage 3, the obtained reproduction-frequency information is stored to form a one-to-one link with data of each piece of music. The reproduction terminal UT registered in the data-providing company's server SV transfers the reproduction-frequency information to the data-providing company's server SV through the data access point DA.

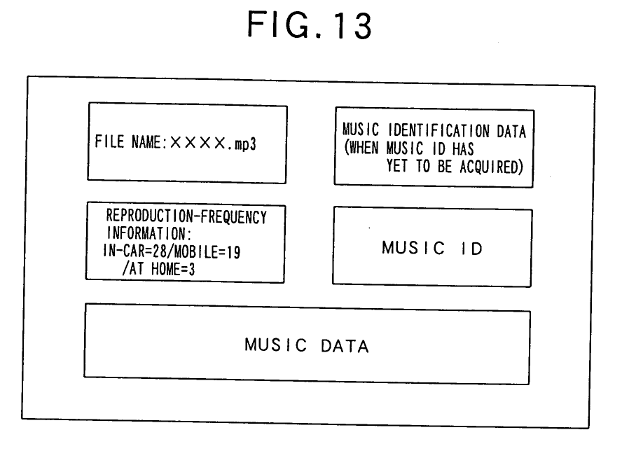

The thus-processed reproduction-frequency information is stored in the terminal storage 3 so as to constitute part of a music data object, as shown in FIG. 13.

Referring to FIG. 13, the music data object stored in the terminal storage 3 of the reproduction terminal UT will now be described. FIG. 13 exemplifies the music data object.

As shown in FIG. 13, the music data object, which is assigned to each piece of music, consists of a file name, music ID to identify each piece of music, reproduction-frequency information, music data, and others.

Of these constituents, if the music ID is yet to be acquired, music identification data is used, instead of the music ID, as data to distinguish this music from other pieces of music. In cases where the music ID is acquired together with music data to be downloaded to the terminal storage 3 via the Internet or others, it is unnecessary to use the music identification data.

The reproduction-frequency information may be stored in various forms in the music data object. For example, the number of reproduction times can be categorized into more precise various aspects, such as reproduction time zones and reproduction modes (for example, in-car, with mobile phone, indoors). Practically, a flag or other information showing the reproduction mode is entered at the terminal operation device 2, so that reproduction-frequency information about a piece of music that has been reproduced, with which the flag is entered, can easily be categorized using the flag. In the similar way to the reproduction mode, the reproduction time zone can be managed. That is, specified time zones (including their dates) each are assigned to management codes in advance, each time zone in which the reproduction is done is examined with reference to an internal clock in the reproduction terminal UT, and reproduction-frequency information about reproduced music is memorized code by code, whereby the categorization based on the reproduction time zone can be made with ease. Such categorization will produce pieces of reproduction-frequency information about music, which are useful in searching a recommended reproduction mode and a recommended reproduction time zone. Processing the reproduction-frequency information in this way makes it possible to analyze the information from various viewpoints, thus providing a helpful tool to music-related business.

The reproduction terminal UT sends the reproduction-frequency information to the data-providing company's server SV, if the user contract is closed with the data providing company.

The data-providing company's server SV is able to have a scheme that gives a global music ID to each piece of reproduction-frequency information. For instance, in cases where music data stored in CDs or other mediums is memorized in the terminal storage 3, a music ID has not still been given to the music data. In that case, some parameters characteristic of waves, which are extracted, as data necessary for identifying music, from wave data of music stored in the reproduction terminal UT, are used as music identification data (that corresponds to the characteristic data of the present invention). When the music ID is yet to be acquired, the music identification data is transmitted from the reproduction terminal UT to the data-providing company's server SV. Responsively to this transmission, the data-providing company's server SV compares the music identification data transmitted from the reproduction terminal UT with music identification data corresponding to registered music data registered in the music database in the data-providing company's server SV. That is, it is determined whether or not there is a match between both types of music identification data (hereafter, this determination is called music identification processing). As a result, if the match is found, a music ID given to the music data is thus given to the music data in the reproduction terminal UT as a global music ID.

Once receiving the music ID as stated above, the reproduction terminal UT uses the received music ID in processing reproduction-frequency information about the same music as that identified by the music ID.

The data-providing company's server SV can collect and analyze, in a consolidated manner, all of reproduction-frequency information and others in relation to music data processed in a plurality of reproduction terminal used by a plurality of uses, respectively, thanks to use of the music IDs.

Next, a series of information accessing flows carried out between the reproduction terminal UT and the data-providing company's server SV will now be carried out.

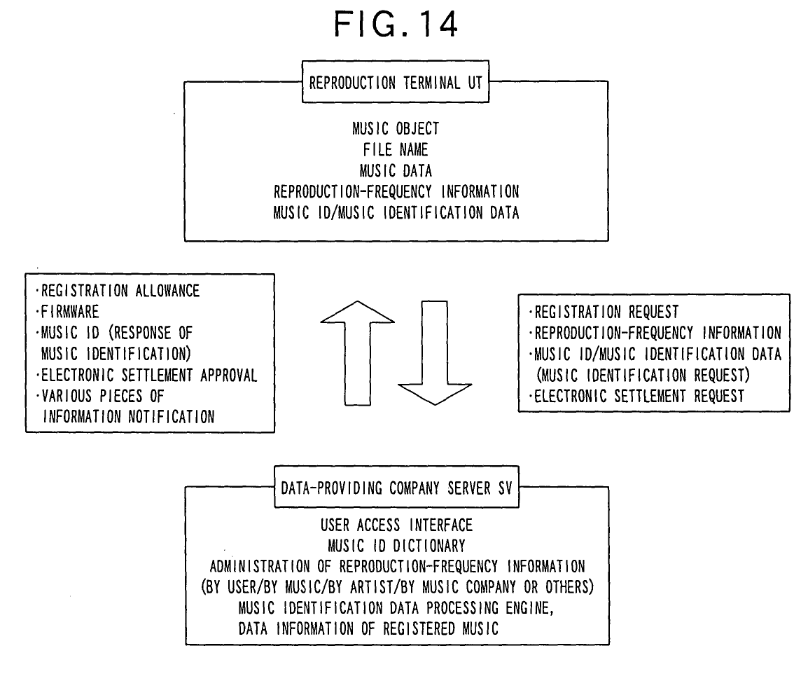

FIG. 14 exemplifies the data transmission/reception between the reproduction terminal UT and the data-providing company's server SV.

As shown in FIG. 14, the reproduction terminal UT has, as one of a plurality of music objects, a file name, music data, reproduction-frequency information, and music ID or music identification data.

Meanwhile, the data-providing company's server SV has a reproduction-frequency information management database, a music information database in which music IDs and music identification data is stored, and others.

Transmitted from the reproduction terminal UT to the data-providing company's server SV are data showing a registration request, reproduction-frequency information, music ID, or music identification data, and others. In contrast, transmitted from the data-providing company's server SV to the reproduction terminal UT are data showing a contract allowance, firmware, music ID, and other various types of information.

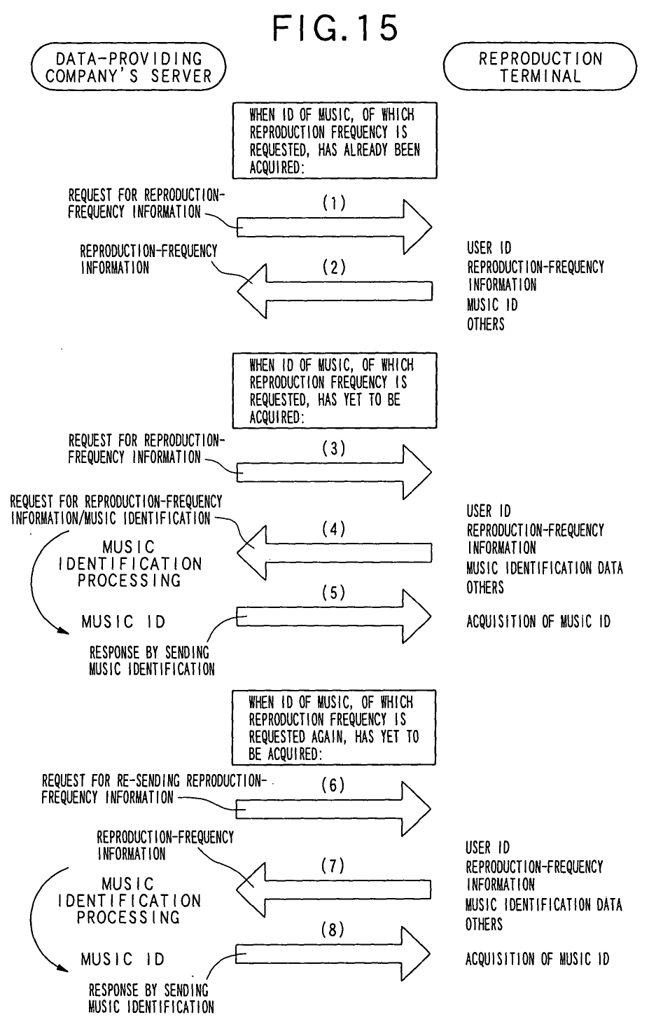

Referring to FIG. 15, the transmission/reception of reproduction-frequency information between a user and the data-providing company will now be described. FIG. 15 exemplifies the contents of such transmission and reception of the reproduction-frequency information.

First explained is a situation in which a music ID has been acquired by the reproduction terminal UT.

From the data-providing company's server SV to the reproduction terminal UT, a request for reproduction-frequency information is transmitted (refer to (1) in FIG. 15).

The reproduction terminal UT, which has received the reproduction-frequency information request, sends information indicative of a user ID, reproduction-frequency information, music ID, and others to the data-providing company's server SV (refer to (2) in FIG. 15).

Secondly, a situation where a music ID is yet to be acquired by the reproduction terminal UT will now be explained.

From the data-providing company's server SV to the reproduction terminal UT, a request for reproduction-frequency information is transmitted (refer to (3) in FIG. 15).

The reproduction terminal, which has received the reproduction-frequency information request, transmits a music identification request as well as a user ID, reproduction-frequency information, music identification data, and others (refer to (4) in FIG. 15).

The data-providing company's server SV, which has received the music identification request, performs music identification processing based on the music identification data and transmits to the reproduction terminal UT a global music ID that correspond to the music identification data (refer to (5) in FIG. 15).

Third, a request for transferring reproduction-frequency information will now be explained.

From the data-providing company's server SV to the reproduction terminal UT, a request for resending reproduction-frequency information is transmitted (refer to (6) in FIG. 15).

The reproduction terminal, which has received the reproduction-frequency information resending request, transmits a music identification request as well as a user ID, reproduction-frequency information, music identification data, and others, if a music ID is yet to be acquired (refer to (7) in FIG. 15).

The data-providing company's server SV responds to the reception of the music identification request by performing music identification processing based on the music identification data and transmitting to the reproduction terminal UT a global music ID corresponding to the music identification data (refer to (8) in FIG. 15).

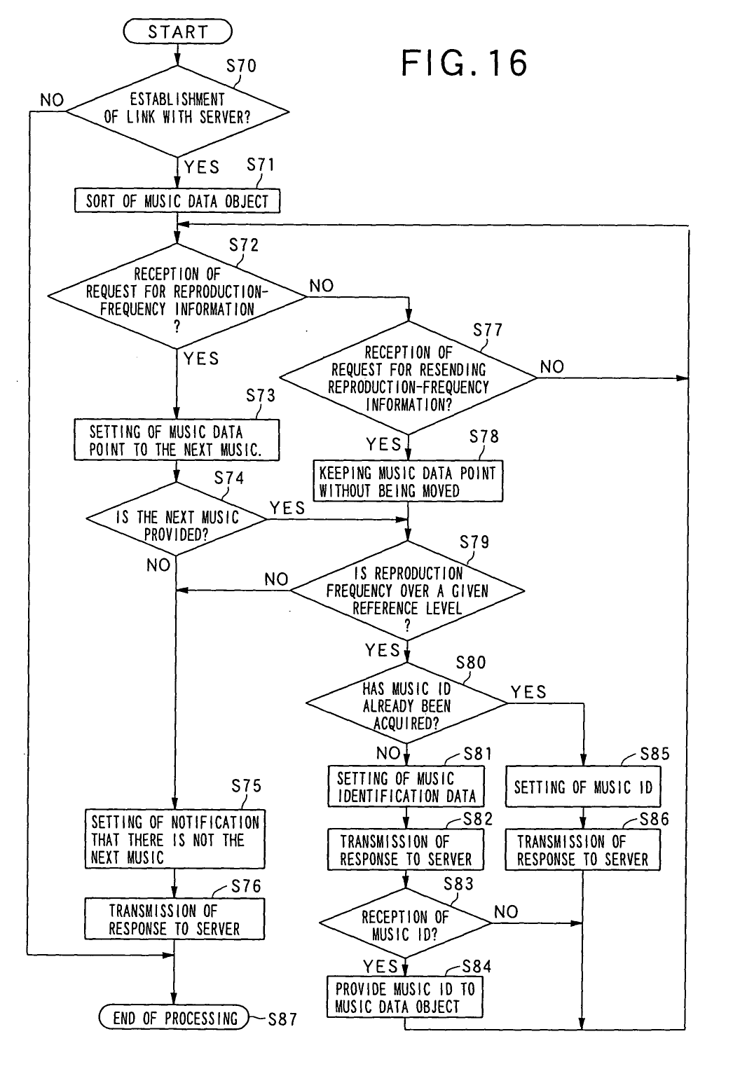

Referring to FIG. 16, the procedures for transmitting and receiving the reproduction-frequency information between the server-providing company and a user who operates the reproduction terminal UT will now be described in terms of the operations carried out by the reproduction terminal UT.

FIG. 16 shows a flowchart of the procedures for transmission and reception of the reproduction-frequency information performed by the reproduction terminal UT.

The terminal processor 1 determines whether or not there is established a link between the data-providing company's server SV and the reproduction terminal UT (step S70 in FIG. 16).

If it is determined that there is no link (NO at step S70), the processing is ended (step S87). Meanwhile, if it is determined that there is such a link (YES at step S70), the terminal processor 1 sorts music data objects so that the music data objects are lined up in the descendent order from the highest reproduction frequency (step S71).

The terminal processor 1 further determines whether or not there is a request for reproduction-frequency information coming from the data-providing company's server SV (step S72).

When it is determined that there is the request for reproduction-frequency information (YES at step S72), the terminal processor 1 sets a music data pointer to the next music (step S73).

The terminal processor goes to the next determination whether or not there is the next music (step S74). If it is determined that there is not the next music (NO at step S74), the terminal processor 1 sets a piece of information indicating that there is no music that includes reproduction-frequency information to be sent (step S75), and transmits the information to the data-providing company's server SV (step S76). After this transmission, the processing is ended (step S87).

If it is determined at step S72 that there is no request for reproduction-frequency information (NO at step S72), the terminal processor 1 further determines if or not there is a request for resending reproduction-frequency information from the data-providing company's server SV (step S77).

When it is determined that there is no resending request (NO at step S77), the processing is returned to step S72.

In contrast, if it is determined that there is such a resending request (YES at step S77), the terminal processor 1 keeps the music data pointer as it is (step S78), then determines whether or not the reproduction frequency of this music is over the given threshold (step S79).

If it is found that the reproduction frequency is equal to or below the given threshold (NO at step S79), the processing is made to proceed to the foregoing step S75.

However, if the determination shows that the reproduction frequency is over the given threshold (YES at step S79), the terminal processor 1 goes to the next determination whether or not the music ID of this music has already been acquired (step S80).

If the determination shows that the music ID has yet to be acquired (NO step S80), the terminal processor 1 sets the music identification data of this music to its music data object (step S81).

The setting of the music identification data is followed by transmitting to the data-providing company's server SV not only the music data object to which the music identification data is set but also a music ID request (step S82).

The terminal processor 1 then determines if or not a global music ID is acquired from the data-providing company's server SV (step S83).

When it is decided that the global music ID is acquired (YES at step S83), the terminal processor 1 relates the music ID to the music data object, before memorizing the music data object into the terminal storage 3 (step S84). After this, the processing is returned to the determination at step S72.

In cases where it is decided that the global music ID has not been received (NO at step S83), the processing is also returned to the determination at step S72.

Meanwhile, it is determined at step S80 that the music ID has already been acquired (YES at step S80), the terminal processor 1 sets the music ID to its music data object (step S85), and sends the music data object to the data-providing company's server SV (step S86).

After the transmission, the processing is returned to step S72 where the terminal processor 1 determines whether there is a request for reproduction-frequency information or not.

If it is determined at step S74 that there exists the next music (YES at step S74), the foregoing determination at step S79 will be performed.

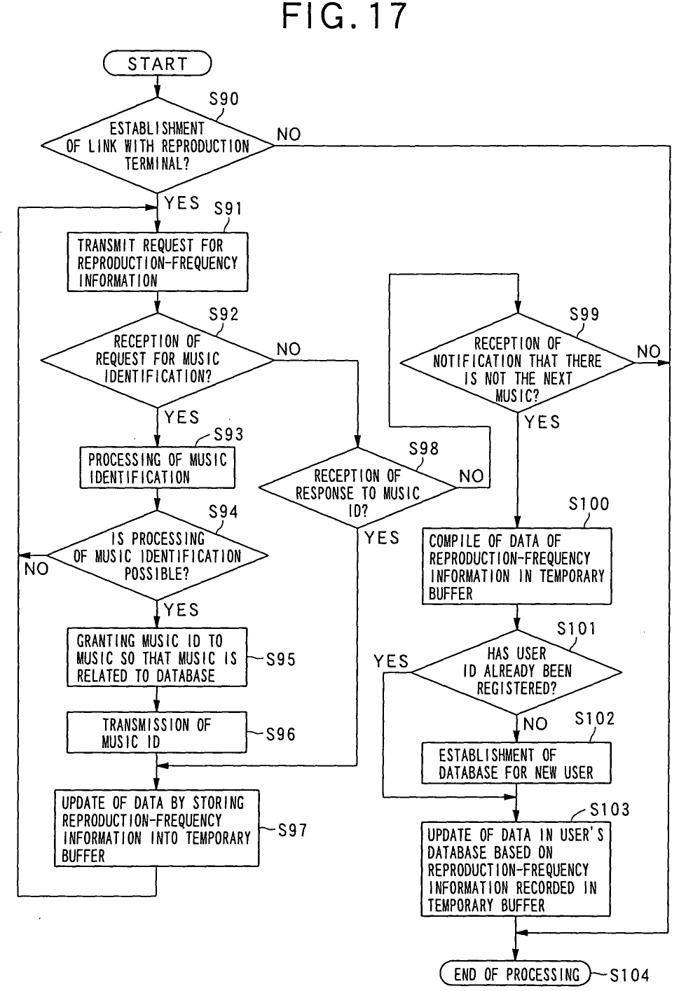

Referring to FIG. 17, the procedures for transmitting and receiving the reproduction-frequency information between the server-providing company and a user who operates the reproduction terminal UT will now be described in terms of the operations carried out by the data-providing company's server SV.

FIG. 17 shows a flowchart of the procedures for transmission and reception of the reproduction-frequency information performed by the data-providing company's server SV.

The server processor 8 determines whether or not there is established a link with the reproduction terminal UT (step S90).

If it is determined that no such a link is established (NO at step S90), the processing is forced to end (step S104). In contrast, it is determined that there is established such a link (YES at step S90), the terminal processor 1 sends to the reproduction terminal UT a request for reproduction-frequency information (step 91).

The server processor 8 further determines whether or not there is a music ID request received from the reproduction terminal UT (step S92).

If it is determined that the music ID request is received (YES at step S92), the server processor 8 performs music identification processing with the use of music identification data that has been received together with the music ID request (step S93).

The server processor 8 uses the results of the music identification processing to examine whether or not it is possible to identify a piece of music (step S94).

If it is examined that the music identification is impossible (NO at step S94), the processing is returned to step S91. However, when the determination is the opposite, that is, the music identification is possible (YES at step S94), a music ID is attached to the music identification data and related to the database in the server storage 7 (step S95).

Then, the music ID is sent to the reproduction terminal UT (step S96).

After the transmission of the music ID, the server processor 8 stores into a temporary buffer the reproduction-frequency information transmitted with the music ID request from the reproduction terminal UT, so that the data is updated.

After the data update, the processing is made to proceed to step S91.

Meanwhile, it is determined at step S92 that the music ID request has not been received (NO at step S92), the server processor 8 determines whether or not reproduction-frequency information has been received together with a music ID (step S98).

If it is determined that the reproduction-frequency information has been received together with the music ID (YES at step S98), the processing proceeds to step S97.

However, if it is determined that that the reproduction-frequency information has yet to be received together with the music ID (NO at step S98), the server processor 8 further determines if or not information indicating that there is no music having reproduction-frequency information to be transmitted has been received from the reproduction terminal UT (step S99).

If it is determined that the information indicating that there is no music having reproduction-frequency information to be transmitted has not been received (NO at step S99), the processing is ended (step S104).

In contrast, it is determined that the information indicating that there is no music having reproduction-frequency information to be transmitted has been received (YES at step S99), the server processor 8 performs the collection of data about the reproduction-frequency information at the temporary buffer (step S100).

The server processor 8 determines whether or not a user ID in association with the reproduction-frequency information recorded in the temporary buffer agrees with the user ID that has already been stored in the database (step S101).

If it is determined that there is no such an agreement (NO at step S101), the server processor 8 adds the user ID of the user to the database (step S102). After the update of the database with the user ID, the database is also updated based on the user's reproduction-frequency information recorded in the temporary buffer (step S103).

The above database is followed by terminating the processing (step S104).

On the other hand, when the reproduction-frequency information recorded in the temporary buffer agrees with the user ID that has already been stored in the database (YES at step S101), the processing proceeds to step S103.

4. Utilization of Reproduction-Frequency Information

How to utilize analyzed results of reproduction-frequency information will now be described.

As described before, the types of data provided from the user to the data providing company include a user ID, music ID, and reproduction-frequency information.

Of these types of information, the user ID can be utilized to obtain information about the gender, age, occupation, and others of each user. The music ID can be utilized to obtain information about an artist's name, music title, genre and others. Further, the reproduction-frequency information can be utilized to obtain information about reproduction time zones (seasons, morning/daytime/night, weekdays, holidays, or others), reproduction modes (in-car, with mobile phone, indoors), and others.

The data-providing company can use these pieces of analyzed information to perform a variety of types of statistic processing over the whole contractors on the data-providing company's server SV. The statistic processing gives the data-providing company with various statistic data including a relationship between each artist and the age brackets of users who listen to the music of the artist; a relationship between a specified genre and the age brackets of users who listen to music falling into the genre; a relationship between seasons and genres; genres of music that is often listened in a car; and others.

In addition, using the above analyzed information makes it possible to provide information about music genres and artists' songs listened frequently by a particular age bracket of people, although not hit currently; music genres and artists gaining gradually increasing popularity; and genres and artists having potential customers.

Therefore, the data-providing company is able to utilize the above analysis to adjust their stocks of CDs, promote pieces of music on the radio and others, and plan various events.

Additionally, age brackets to be targeted can be divided more finely, and various kinds of information can be introduced to the finely divided age brackets of people, such information including introduction of artists in related genres, music of related genres, related roots (history), new music of artists, events related to artists, and others. This is helpful in finding potential needs to music.

An accounting system adopted in the present embodiment will now be explained, which is required when the analyzed information as stated above is provided to each company of the music industry, such as the broadcasting company.

First, in order to closing a contract with each music-related company, an initial license fee is decided to hold the contract.

It is possible to provide the information in a one-time basis, but in such a case, an information-providing fee rate can be raised instead of getting in the initial fee.

Further, a metered-rate accounting system depending on the degree of data analysis is adopted.

In the present accounting system, in addition to the initial license fee, an extra fee system can be set, the extra system fee depending on the degree of data analysis every time when an analysis is requested. For instance, when analyzing data is requested genre by genre, for example, for each of four genres of “Rock,” “Jazz,” “Classic,” and “others,” a metered-rate fee is required for four divisions each corresponding to each genre.

For a further detailed data analysis, a further fee is added at a metered rate depending on analyzed levels of information, such a detailed data analysis being for example “Rock and Japanese Artists” or “thirtysomething men's favorite JPOP artists.”An alternative business for feeding information back to the user who allows reproduction-frequency information to be provided is carried out by the data-providing company. A fee necessary for providing this information to the user is also collected by the data-providing company.

In the case that a new album on the CD is desired to be introduced to the user, the introduction can be made toward only users whose reproduction-frequency information is provided to the data-providing company and subjected to the analysis to be chosen, not all the users who just provided reproduction-frequency information.

In such a case, it is actually difficult for an album sales company to directly inform users of the information, due to privacy issues. Hence, the data-providing company intervenes between the album sales company and the users to deliver such information to the users.

For example, the album sales company is to specify their desired words, such as “an age bracket of people who seem to like a particular piece of music, artist, genre, and/or others.” In response to this specification, the data-providing company is able to extract users whose analyzed results agree with the specifications, from the statistically analyzed data about the reproduction-frequency information, which has been stored in the data-providing company's server SV. Information desired by the album sales company is delivered to the reproduction terminals UT of the extracted users via the data access point DA.

Between the data-providing company and each of the broadcasting, album producing, album sales and production companies, a business contract is closed, so that the analyzed data of the reproduction-frequency information is bought and sold for utilization in their business.

That is, each company on the music industry buys the analyzed data of the users' reproduction-frequency information from the data-providing company's server SV through the communication means, and applies information processing to the bought data on their terminal.

For instance, the broadcasting company receives the analyzed data of the reproduction-frequency information on their broadcasting company's terminal HT. The terminal HT performs various types of information processing on the analyzed data as well as their own business data. By this information processing, information about programs in which users' favorite artists participate is produced and delivered to each user.

The album producing and album sales companies receive the analyzed data of the reproduction-frequency information on their album-producing company's terminal RT and album-sales company's terminal ST. Like the above, each of the terminals RT and HT performs various types of information processing on the analyzed data as well as their own business data. By this information processing, information about various items, such as introduction of new albums that almost agree with each user's favorite and special sales, can be provided to each user. In addition, monitoring and analyzing a trend derived from the reproduction-frequency information will lead to well controlled adjustment for pressing CDs, thus leading to well controlled stocks.

In the case of the production company, the analyzed data of the reproduction-frequency information is read by the production company's terminal PT, where various type of information processing is performed on the analyzed data as well as their own business data. Hence, it is possible to provide each user with concert information, information about artist introduction, information about sales of related goods, and others, which are almost processed to be agreeable with the user's favorite.

Providing the above various kinds of information from the broadcasting, album producing, album sales, and production companies to the users is carried out by the data-providing company's server SV to the reproduction terminal UT of each user.

For instance, concert information processed by the production company's terminal PT so as to be different in contents user by user is transmitted to the data-proving company's server SV via the communication means. The data-providing company's server SV then delivers the received information to the user's reproduction terminal UT via the data access point DA. This enables each user to have various types of user's favorite information, including new album information, concert information, program appearance information, which are related to the user's favorite artists, in a timely manner. It is therefore expectable that buying inclination for new albums and concert tickets and interest in music are raised. Further, the user is also able to have information about genres, artists and others in which the user has had no interest, due to no information about such kind of information. Such a fine and well-analyzed way of providing information will make lots of people show their interest in a wider range of music fields, which is helpful in increasing people who are potentially interested in music.

As stated above, with the system of the present invention can provide an effect that companies of music industry can figure out each user's taste in detail, which makes it possible to develop potential demand of consumers.

As an additional effect, music industry can execute a suggesting music-related business, because it is possible to provide information about the genre and artist, catch the needs and develop seeds respecting each individual user.

From this point of view, moreover, the other effects as follows can be expected.

First, it is prospective that a movement of so-called “turnoff of adult from music” would be dissolved. The tendency of “turnoff of adult from music” has been furthered due to the fact that a marketable musical component becomes unsuited to one's taste as he or she grows into an adult.

Furthermore, many of marketable pieces of music has been favored by teenagers who have not much money to spare, which brings a less benefits in business, because such bracket often avail themselves of rental and/or copy. The above mentioned enhancement of buying inclination of adult age would prospectively enlarge benefits of music-related business as a whole.

For the sake of completeness, it should be mentioned that the embodiment explained so far is not a definitive list of possible embodiments of the present invention. The expert will appreciates that it is possible to combine the various construction details or to supplement or modify them by measures known from the prior art without departing from the basic inventive principle.

The entire disclosure of Japanese Patent Application No. 2002-206461 filed on Jul. 16, 2002 including the specification, claims, drawings and summary is incorporated herein by reference in its entirety.

What is claimed is:

1. A system for processing reproduction-frequency information, comprising:
a plurality of terminals each configured to record one or more pieces of information and to reproduce the recorded information; and
a server system communicably connected with the plurality of terminals via communication means and configured to perform statistic processing on a reproduced condition of the recorded information at the terminals,
wherein each terminal comprises
calculation means configured to calculate reproduction-frequency information, every piece of the one or more pieces of recorded information, depending on the reproduced condition of each of the one or more pieces of recorded information,
information memorizing means configured to memorize the calculated reproduction-frequency information,
reproduction-frequency information request receiving means configured to receive from the server system a request for the reproduction-frequency information, and
terminal transmission means configured to transmit the memorized reproduction-frequency information to the server system; and
wherein the server system comprises
information request means configured to request a certain terminal for the reproduction-frequency information,
reproduction-frequency information receiving means configured to receive the reproduction-frequency information from the terminal, and
statistic processing means configured to perform the statistic processing based on the received reproduction-frequency information.

2. The system according to claim 1, wherein each of the terminals comprises
identification sign request means configured to, in cases where it is impossible for the terminal to identify a piece of recorded information, transmit, to the server system, characteristic data extracted from the recorded information and to request the server system for an identification sign to identify the recorded information, and
identification sign receiving means configured to receive from the server system the identification sign of the recorded information, and
wherein the server system comprises
identification sign request receiving means configured to receive from a certain terminal the identification sign request means as well as the characteristic data,
recorded-information determining means configured to determine whether or not the received characteristic data is the same as characteristic data corresponding to recorded information previously registered by making comparison between both of the characteristic data, and
identification sign transmitting means configured to transmit to the terminal an identification sign corresponding to registered record information about characteristic data which has been determined to be the same as the received characteristic data,
wherein the terminal transmission means is configured to transmit to the server system the identification sign corresponding to the reproduction-frequency information as well as the memorized reproduction-frequency information, and
the reproduction-frequency information receiving means is configured to receive from the terminal the identification sign corresponding to the reproduction-frequency information as well as the reproduction-frequency information.

3. The system according to claim 1, wherein the calculation means is configured to calculate the number of times of reproduction every time when the recorded information is continuously reproduced longer than a given period of time.

4. The system according to claim 1, wherein the terminal transmission means is configured to transmit only reproduction-frequency information indicative of a frequency higher than a reference frequency previously determined.

5. The system according to claim 1, wherein the recorded information includes information indicating sound.

6. A method of processing reproduction-frequency information, which is carried out in a reproduction-frequency information processing system comprising: a plurality of terminals each configured to record one or more pieces of information and to reproduce the recorded information; and a server system communicably connected with the plurality of terminals via communication means and configured to perform statistic processing on a reproduced condition of the recorded information at the terminals, the processing method comprising the steps of:
calculating reproduction-frequency information every piece of the one or more pieces of recorded information depending on the reproduced condition of each of the one or more pieces of recorded information, the calculation being carried out in each of the terminals;
memorizing the calculated reproduction-frequency information, the memorization being carried out in each of the terminals;
receiving from the server system a request for the reproduction-frequency information, the reception being carried out in each of the terminals; and
transmitting the memorized reproduction-frequency information to the server system, the transmission being carried out in each of the terminals;
requesting a certain terminal for the reproduction-frequency information, the request being carried out in the server system;
receiving the reproduction-frequency information from the terminal, the reception being carried out in the server system; and
performing the statistic processing based on the received reproduction-frequency information, the performance being carried out in the server system.

7. A server system included in a reproduction-frequency information processing system according to claim 1, the server system comprising:
the information request means;
the reproduction-frequency information receiving means; and
the statistic processing means.

8. A terminal included in a reproduction-frequency information processing system according to claim 1, the terminal comprising:
the calculation means;
the information memorizing means;
the reproduction-frequency information request receiving means; and
the terminal transmission means.

9. An information processing terminal comprising information processing means configured to perform information processing using information derived from the statistic processing carried out in a reproduction-frequency information processing system according to claim 1.

10. A recording medium in which a server program is recorded so that the server program is recordable by a server computer incorporated in the server system according to claim 1, wherein the server program allows the server computer to function as:
the information request means;
the reproduction-frequency information receiving means; and
the statistic processing means.

11. A recording medium in which a terminal program is recorded so that the terminal program is recordable by a terminal computer incorporated in the terminal according to claim 1, wherein the terminal program allows the terminal computer to function as:
the calculation means;
the information memorizing means;
the reproduction-frequency information request receiving means; and
the terminal transmission means.
